(19) United States
(12) Patent Application Publication
(10) Pub. No.: US 2009/0302854 A1
(43) Pub. Date: Dec. 10, 2009

(54) Apparatus for Formation Resistivity Imaging in Wells with Oil-Based Drilling Fluids

(75) Inventors: Stanislav W. Forgang, Houston, TX (US); Randy Gold, Houston, TX (US)

Correspondence Address: MADAN & SRIRAM, P.C., 2603 AUGUSTA DRIVE, SUITE 700, HOUSTON, TX, 77057-5662, US

(73) Assignee: BAKER HUGHES INCORPORATED, Houston, TX (US)

(21) Appl. No.: 12/136,208

(22) Filed: Jun. 10, 2008

(51) Int. Cl. G01V 3/24

(52) U.S. Cl. 324/355

(57) ABSTRACT

Sequential measurements are made using a two terminal resistivity imaging device wherein the measure electrodes are activated sequentially with the remaining electrodes in a floating mode. This eliminates the hardware requirements for focusing electrodes, prevents galvanic leakage between proximal electrodes and the effects of mutual coupling between circuits including proximal electrodes.

### BACKGROUND OF THE INVENTION

1. Field of the Invention

This invention generally relates to exploration for hydrocarbons involving electrical investigations of a borehole penetrating an earth formation. More specifically, this invention relates to highly localized borehole investigations of multifrequency focusing of survey currents injected into the wall of a borehole by capacitive coupling of electrodes on a tool moved along the borehole with the earth formation.

2. Background of the Art

Electrical earth borehole logging is well known and various devices and various techniques have been described for this purpose. Broadly speaking, there are two categories of devices used in electrical logging devices. In the first category, a measure electrode (current source or sink) are used in conjunction with a diffuse return electrode (such as the tool body). A measure current flows in a circuit that connects a current source to the measure electrode, through the earth formation to the return electrode and back to the current source in the tool. In inductive measuring tools, an antenna within the measuring instrument induces a current flow within the earth formation. The magnitude of the induced current is detected using either the same antenna or a separate receiver antenna. The present invention belongs to the first category.

There are several modes of operation. In one, the current at the measuring electrode is maintained constant and a voltage is measured, while in the second mode, the voltage of the electrode is fixed and the current flowing from the electrode is measured. Ideally, it is desirable that if the current is varied to maintain at a constant value the voltage between measure and return electrodes, the current is inversely proportional to the resistivity of the earth formation being investigated. Conversely, it is desirable that if this current is maintained constant, the voltage measured between monitor electrodes is proportional to the resistivity of the earth formation being investigated. Ohm's law teaches that if both current and voltage vary, the resistivity of the earth formation is proportional to the ratio of the voltage to the current.

Birdwell (U.S. Pat. No. 3,365,658) teaches the use of a focused electrode for determination of the resistivity of subsurface formations. A survey current is emitted from a central survey electrode into adjacent earth formations. This survey current is focused into a relatively narrow beam of current outwardly from the borehole by use of a focusing current emitted from nearby focusing electrodes located adjacent the survey electrode and on either side thereof. Ajam et al (U.S. Pat. No. 4,122,387) discloses an apparatus wherein simultaneous logs may be made at different lateral distances through a formation from a borehole by guard electrode systems located on a sonde which is lowered into the borehole by a logging cable. A single oscillator controls the frequency of two formation currents flowing through the formation at the desired different lateral depths from the borehole. The armor of the logging cable acts as the current return for one of the guard electrode systems, and a cable electrode in a cable electrode assembly immediately above the logging sonde acts as the current return for the second guard electrode system. Two embodiments are also disclosed for measuring reference voltages between electrodes in the cable electrode assembly and the guard electrode systems.

Techniques for investigating the earth formation with arrays of measuring electrodes have been proposed. See, for example, the U.S. Pat. No. 2,930,969 to Baker, Canadian Patent No. 685727 to Mann et al., U.S. Pat. No. 4,468,623 to Gianzero, and U.S. Pat. 5,502,686 to Dory et al. The Baker patent proposed a plurality of electrodes, each of which was formed of buttons which are electrically joined by flexible wires with buttons and wires embedded in the surface of a collapsible tube. The Mann patent proposes an array of small electrode buttons either mounted on a tool or a pad and each of which introduces in sequence a separately measurable survey current for an electrical investigation of the earth formation. The electrode buttons are placed in a horizontal plane with circumferential spacings between electrodes and a device for sequentially exciting and measuring a survey current from the electrodes is described.

The Gianzero patent discloses tool mounted pads, each with a plurality of small measure electrodes from which individually measurable survey currents are injected toward the wall of the borehole. The measure electrodes are arranged in an array in which the measure electrodes are so placed at intervals along at least a circumferential direction (about the borehole axis) as to inject survey currents into the borehole wall segments which overlap with each other to a predetermined extent as the tool is moved along the borehole. The measure electrodes are made small to enable a detailed electrical investigation over a circumferentially contiguous segment of the borehole so as to obtain indications of the stratigraphy of the formation near the borehole wall as well as fractures and their orientations. In one technique, a spatially closed loop array of measure electrodes is provided around a central electrode with the array used to detect the spatial pattern of electrical energy injected by the central electrode. In another embodiment, a linear array of measure electrodes is provided to inject a flow of current into the formation over a circumferentially effectively contiguous segment of the borehole. Discrete portions of the flow of current are separately measurable so as to obtain a plurality of survey signals representative of the current density from the array and from which a detailed electrical picture of a circumferentially continuous segment of the borehole wall can be derived as the tool is moved along the borehole. In another form of an array of measure electrodes, they are arranged in a closed loop, such as a circle, to enable direct measurements of orientations of resistivity of anomalies. U.S. Pat. No. 6,714,014 to Evans et al, having the same assignee as the present invention and the contents of which are incorporated herein by reference, teaches the use of capacitive coupling with the formation through both oil-based mud and water-based mud.

The Dory patent discloses the use of an acoustic sensor in combination with pad mounted electrodes, the use of the acoustic sensors making it possible to fill in the gaps in the image obtained by using pad mounted electrodes due to the fact that in large diameter boreholes, the pads will necessarily not provide a complete coverage of the borehole.

The prior art devices, being contact devices, are sensitive to the effects of borehole rugosity: the currents flowing from the electrodes depend upon good contact between the electrode and the borehole wall. If the borehole wall is irregular, the contact and the current from the electrodes are irregular, resulting in inaccurate imaging of the borehole. A second drawback is the relatively shallow depth of investigation caused by the use of measure electrodes at the same potential as the pad and the resulting divergence of the measure currents. U.S. Pat. No. 6,809,521 to Tabarovsky et al. discloses a multi-frequency method for determination of formation resistivity. The assumption made in Tabarovsky is that

$$\frac{{σ}_{1}}{{ɛ}_{1}} << ω << \frac{{σ}_{2}}{{ɛ}_{2}}$$

where the σ's are conductivities, the ε's are dielectric constant, ω is the operating frequency, the subscript 1 refers to the mud and the subscript 2 refers to the formation. The first of the two inequalities is easily satisfied with oil based mud where the mud conductivity is extremely small. However, if the mud has a finite conductivity, the condition is hard to satisfy. It would be desirable to have an apparatus and method of determination of formation resistivity that is relatively insensitive to borehole rugosity and can be used with either water based or with oil-based muds for a wide range of formation resistivities. The present invention satisfies this need.

U.S. patent application Ser. No. 11/209,532 of Bespalov et al., having the same assignee as the present disclosure and the contents of which are incorporated herein by5 reference, discloses a dual frequency apparatus and method for borehole resistivity imaging. There are a number of technically challenging issues that still remain. One of these is the elimination of “galvanic” cross-talk between sensor electrodes through non-conductive mud and a conductive formation. This error becomes more pronounced in the presence of borehole rugosity when the sensor experience uneven standoff from the formation. Another problem with multi-electrode imaging tools is the presence of mutual inductive coupling between circuits defined by the individual button electrodes. Most importantly, while prior art methods recognize the need for methods and hardware for maintaining the buttons at equipotential using, for example, focusing electrodes, this still remains a difficult technical problem at elevated frequencies (in the MHz range). In addition, multifrequency methods require that each of the amplifiers be maintained at proper tuning at a plurality of frequencies.

### SUMMARY OF THE INVENTION

One embodiment of the disclosure is a method of imaging a resistivity property of a subsurface material. The method includes conveying a logging tool having a plurality of measure electrodes into a borehole and reducing a mutual coupling between at least one pair of the plurality of measure electrodes. A first measure current having a first frequency is conveyed through a first one of the at least one pair of measure electrodes and a second measure current at the first frequency is conveyed through a second one of the at least one pair of measure electrodes. A 2-D image of the resistivity property of the subsurface material is produced using a value of the first measure current and a value of the second measure current. The mutual coupling between the at least one pair of measure electrodes may be reduced introducing a series impedance with each of the at least one pair of measure electrodes. The series impedance may be a resistance, a capacitance, and/or an inductance. The mutual coupling may be reduced by increasing a spacing between the at least one pair of measure electrodes. The mutual coupling maybe reduced by floating the second one of the at least one pair of measure electrodes while conveying the measure current through the first one of the at least one pair of measure electrodes, and floating the first one of the at least one pair of measure electrodes while conveying the measure current through the second one of the at least one pair of measure electrodes. The method may include using a return electrode to return the first measure current and the second measure current. Floating any of the plurality of electrodes may be done by disconnecting an electrical connection, and/or disabling an input to an amplifier. The method may include conveying the logging tool on a bottomhole assembly on a drilling tubular, or a downhole logging string conveyed on a wireline.

Another embodiment is an apparatus for imaging a resistivity property of a subsurface material. The apparatus includes a logging tool having a plurality of measure electrodes configured to be into a borehole, the logging tool including circuitry configured to reduce a mutual coupling between at least one pair of the plurality of measure electrodes. The apparatus also includes at least one processor configured to convey a first measure current having a first frequency through a first, single one of the at least one pair of measure electrodes, convey a second measure current at the first frequency through a second, single one of the at least one pair of measure electrodes; and produce an image of the borehole wall of the resistivity property of the subsurface material using a value of the first measure current and a value of the second measure current. The circuitry may include a series impedance with each of the at least one pair of measure electrodes. The series impedance may be a resistance, a capacitance, and/or an inductance. The apparatus circuitry may further include a processor configured to float the second one of the at least one pair of measure electrodes while conveying the measure current through the first one of the at least one pair of measure electrodes, and a processor configured to float the first one of the at least one pair of measure electrodes while conveying the measure current through the second one of the at least one pair of measure electrodes. The apparatus may include a return electrode configured to return the first measure current and the second measure current. The processor may be further configured to float any of the plurality of electrodes by disconnecting an electrical connection, and/or disabling an input to an amplifier. The apparatus may include a conveyance device configured to convey the logging tool into the borehole, the conveyance device being a drilling tubular configured to convey a bottomhole assembly, or a wireline configured to convey a logging string.

Another embodiment is a computer-readable medium for use with an apparatus for imaging a resistivity property of a subsurface material. The apparatus includes a logging tool having a plurality of measure electrodes configured to be into a borehole the logging tool including circuitry configured to reduce a mutual coupling between at least one pair of the plurality of measure electrodes. The medium includes instructions that enable at least one processor to convey a first measure current having a first frequency through a first single one of the at least one pair of measure electrodes, convey a second measure current at the first frequency through a second single one of the plurality of measure electrodes produce an image of the borehole wall of the resistivity property of the subsurface material using a value of the first measure current and a value of the second measure current. The computer-readable medium may be a ROM, an EPROM, an EAROM, a flash memory, and/or an optical disk.

### BRIEF DESCRIPTION OF THE FIGURES

The present invention is best understood with reference to the accompanying figures in which like numerals refer to like elements and in which:

FIG. 1 (prior art) shows an exemplary logging tool suspended in a borehole;

FIG. 2A (prior art) is a mechanical schematic view of an exemplary imaging tool;

FIG. 2B (prior art) is a detail view of an electrode pad of an exemplary logging tool;

FIG. 3 is a schematic circuit diagram corresponding to an ideal two-electrode imaging system;

FIG. 4 shows the mutual coupling between current flows in two electrodes;

FIG. 5 shows the equivalent circuit for the mutual coupling between current flows in the two electrodes;

FIG. 6 shows a phasor diagram of the currents in two electrodes, the induced EMF and the parasitic current;

FIG. 7 shows an equivalent Wheatstone bridge configuration of two button electrodes in combination with equivalent formation and mud electrical parameters to demonstrate the current imbalance due to uneven standoff;

FIG. 8 is schematic diagram of some aspects of the present disclosure; and

FIG. 9 is an exemplary image display of the Baker Hughes Earth Imager®.

### DETAILED DESCRIPTION OF THE INVENTION

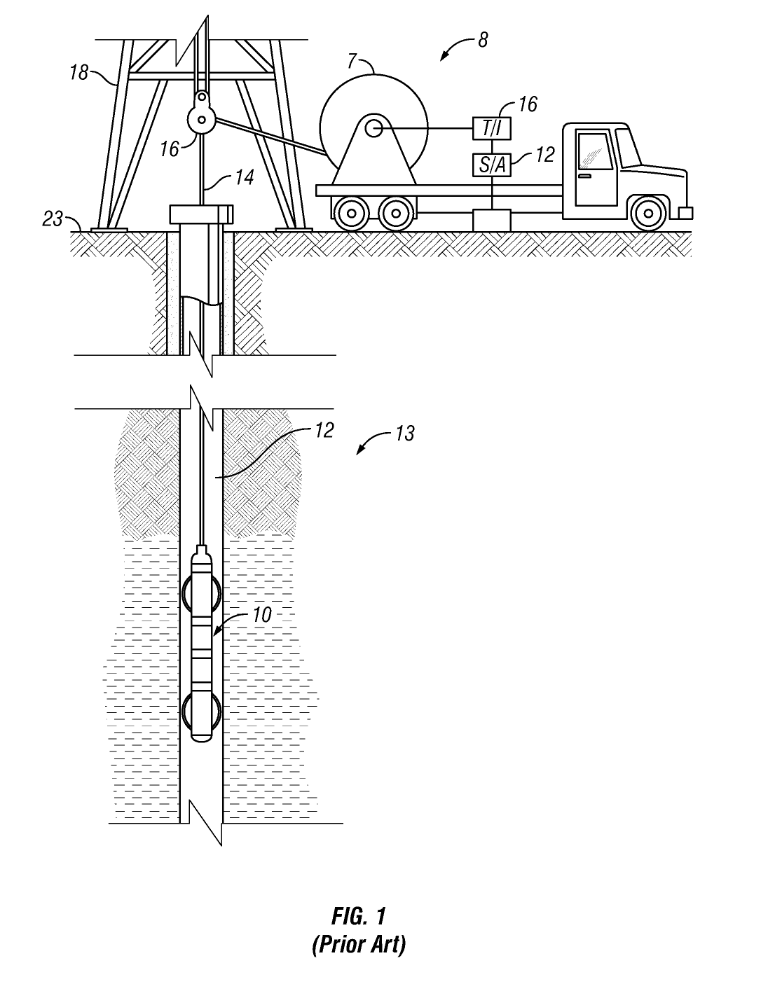

FIG. 1 shows an exemplary imaging tool 10 suspended in a borehole 12, that penetrates earth formations such as 13, from a suitable cable 14 that passes over a sheave 16 mounted on drilling rig 18. By industry standard, the cable 14 includes a stress member and seven conductors for transmitting commands to the tool and for receiving data back from the tool as well as power for the tool. The tool 10 is raised and lowered by draw works 20. Electronic module 22, on the surface 23, transmits the required operating commands downhole and in return, receives data back which may be recorded on an archival storage medium of any desired type for concurrent or later processing. The data may be transmitted in analog or digital form. Data processors such as a suitable computer 24, may be provided for performing data analysis in the field in real time or the recorded data may be sent to a processing center or both for post processing of the data.

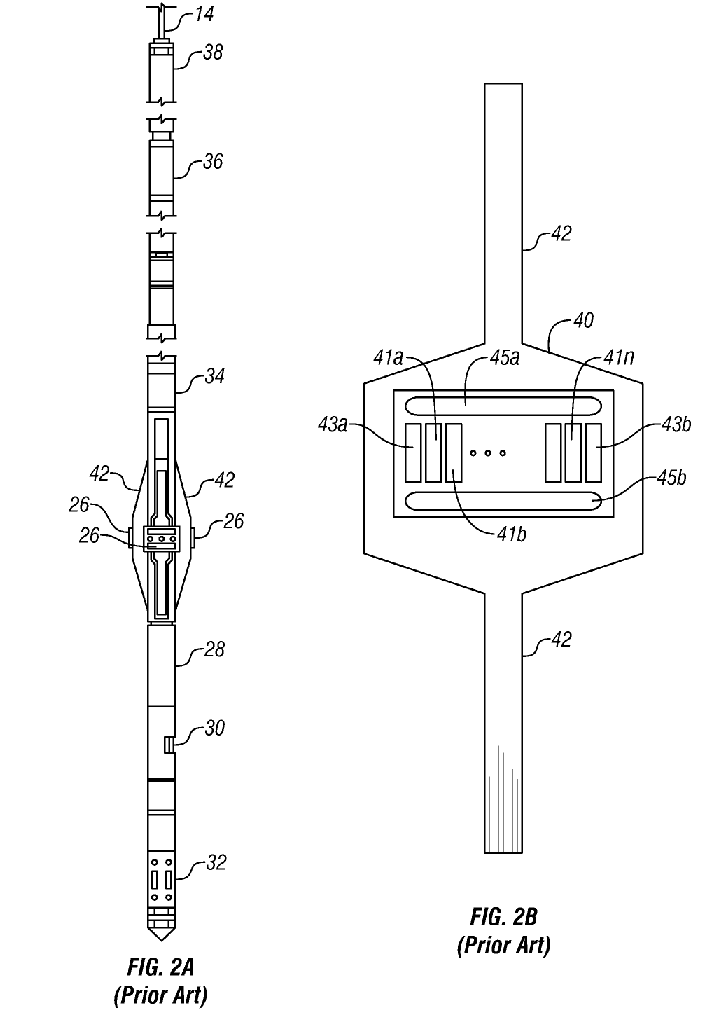

FIG. 2A is a schematic external view of a borehole sidewall imager system. The tool 10 comprising the imager system includes resistivity arrays 26 and, optionally, a mud cell 30 and a circumferential acoustic televiewer 32. Electronics modules 28 and 38 may be located at suitable locations in the system and not necessarily in the locations indicated. The components may be mounted on a mandrel 34 in a conventional well-known manner. The outer diameter of the assembly is about 5 inches and about fifteen feet long. An orientation module 36 including a magnetometer and an accelerometer or inertial guidance system may be mounted above the imaging assemblies 26 and 32. The upper portion 38 of the tool 10 may contain a telemetry module for sampling, digitizing and transmission of the data samples from the various components uphole to surface electronics 22 in a conventional manner. If acoustic data are acquired, they are preferably digitized, although in an alternate arrangement, the data may be retained in analog form for transmission to the surface where it is later digitized by surface electronics 22.

Also shown in FIG. 2A are three resistivity arrays 26 (a fourth array is hidden in this view. Referring to FIGS. 2A and 2B, each array includes measure electrodes 41a, 41b, . . . 41n for injecting electrical currents into the formation, focusing electrodes 43a, 43b for horizontal focusing of the electrical currents from the measure electrodes and focusing electrodes 45a, 45b for vertical focusing of the electrical currents from the measure electrodes. By convention, “vertical” refers to the direction along the axis of the borehole and “horizontal” refers to a plane perpendicular to the vertical.

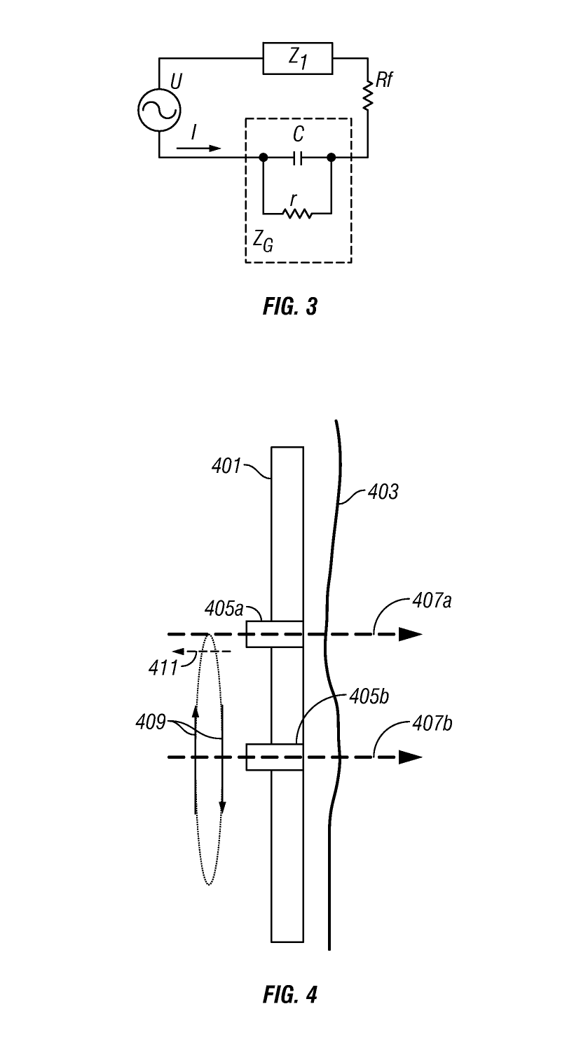

The approximate imaging schematic circuit diagram for an ideal two-electrode case (single sensor electrode and return electrode) is presented in FIG. 3. It shows that the measured effective impedance Zₑ depends on the internal impedance of the tool Zᵣ, the impedance due to the gap between sensor electrode and formation Z_{G} and effective formation resistance R_{f}. With the measurement condition for operating frequency set per Tabarovsky the effective formation resistance R_{f} is proportional to formation resistivity (or in converse with formation conductivity). The impedance appearing between the return electrode and the formation could be ignored as being very small compared to others. This is a reasonable assumption due to the large area of the return electrode. If U is the applied voltage and I is the measured current then the complex impedance Zₑ is

$${Z}_{e} = {Z}_{T} + {Z}_{G} + {R}_{f} = \frac{U}{I} . \qquad ( 1 )$$

In case of a conductive formation (with a resistivity less than 10 Ω-m) and oil-based mud, the contribution of the formation into the effective impedance becomes small R_{f}<<<Z_{T}+Z_{G} which results in a reduction of the sensitivity of the measured impedance to the resistivity of formation. The gap impedance Z_{G}, which depends on the mud properties and the receiver standoff, becomes a major contributor to the effective impedance. Typically, Z_{T} is negligible and could be excluded from considerations for on-pad oil-based imagers.

Notice that there the current flow through a button follows a path that typically includes transmitter (return) electrode—formation—mud—button—electronics and back to transmitter electrode. The path has complex impedance which is dominated by the gap capacitive reactance in oil-based mud. Some inductive reactance might also be present due to path length. However, the locality of measurements in the current disclosure makes it negligible. See, for example, U.S. Pat. No. 6,714,014 to Evans et al.

An effect that can not be ignored is the mutual magnetic coupling between these current paths and particularly in the areas where current paths become separated. This happens when currents leave a conductive formation and then flow through mud to buttons. This is illustrated in FIG. 4 where the pad is depicted by 401, two button electrodes are denoted by 405a, and 405b, and the borehole wall by 403.

The currents in the two electrodes are denoted by 407a, 407b. The current 407b produces a magnetic field denoted by 409 that, in turn, crosses the conduction path of the neighboring electrode 405a, thus inducing a current denoted by 411 in the first electrode 405a.

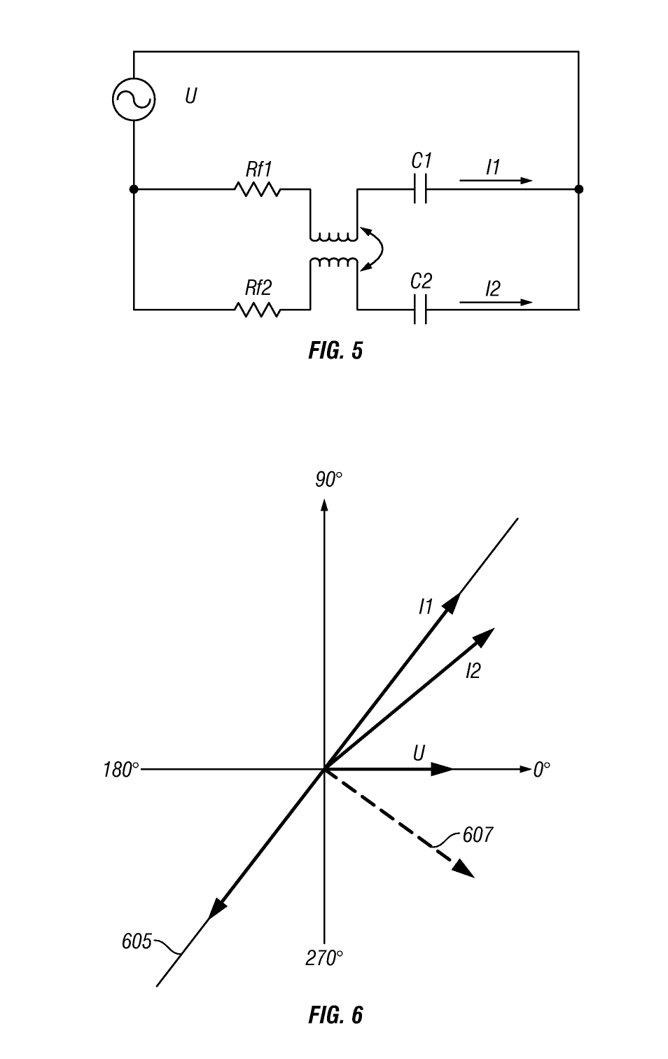

The equivalent circuit for this is depicted in FIG. 5. The currents in the two flow paths are depicted by 11 and 12 respectively and M is the mutual inductance. According to Faraday's Law the induced EMF would be proportional to the operating frequency and generates a compensation current in the neighboring conduction path. Upon a detailed analysis, it is found that in general case of oil-based mud imaging, the phase of these parasitic current would be almost 90° behind the phase of measured current.

Referring to FIG. 6, the phasor diagram of the currents and voltages is shown. The currents in the two electrodes are denoted by 11 and 12. The phase difference between the two may be due to differences in capacitances arising from standoff differences of the two electrodes from the borehole wall. The induced EMF is denoted by 605. The parasitic current induced is indicated by 607.

Generalizing the discussion to a plurality of electrodes, we conclude that:
there is a particular preferable conduction path associated with a particular sensor M from the total set of N buttons;
every sensor current becomes a vector sum of the measure current I_{M} and at least N−1 parasitic currents due to magnetic coupling with neighboring paths associated with sensors number 1, 2, . . . M−1, M+1, . . . N);
the vector sum of parasitic currents would have a phase that is different from the phase of measure current. If mud reactance dominates in the overall impedance in front of the pad, the phase of vector sum would be close to 90° behind the phase of current I_{M}.; and
this effect could produce a significant error in post-processing estimation of Z_{G} and R_{F}, often resulting in obtaining both gap width and formation resistivity well above the actual values.

Another resistivity imaging problem associated with current re-distribution in the formation has been noted before in oil-based imagers. See, for example, U.S. Pat. No. 6,714,014 to Evans et al. Conventionally it has been called as a “defocusing” of the high frequency button current if a neighboring conductive pad structure is presented. See, for example, U.S. patent application Ser. No. 11/758,875 of Itskovich et al., filed on Jun. 6, 2007, having the same assignee as the present disclosure and the contents of which are incorporated herein by reference. As disclosed therein, the button and pad body are kept under the same potential as the sensor.

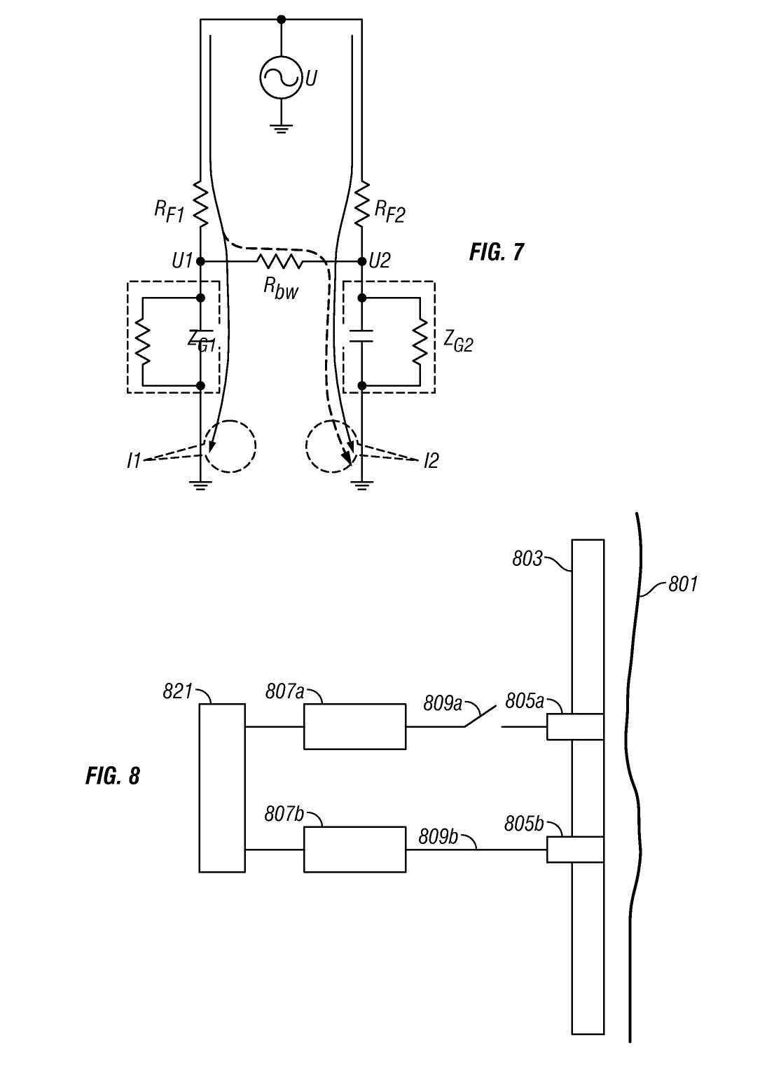

The simplified physics of this effect could be seen through example is based on equivalent Wheatstone bridge presentation and includes two neighboring buttons. As one can see from the FIG. 7, even in case of homogeneous formation (R_{F1}=R_{F2}) the high impedance mud and uneven button standoff (Z_{G1}>Z_{G2}) create a potential distribution, primarily along the borehole wall (across resistor R_{bw}). In a first approximation this happens due to apparent differences in both magnitudes and phases of Z_{G}, with a minor effect due to formation impedances. The bridge's legs become unbalanced (U1≠U2) and current appears in the diagonal. Following Ohm's Law, a significant portion of this current which would otherwise be going in the sensor #1 with a bigger standoff will now flow in the sensor #2 where the gap is smaller. As a result the image losses its fidelity, becomes distorted and smeared in details.

Providing for a high level of button equipotentiality has remained a challenge at higher frequencies. The sensor current has to be measured while entering the button and at elevated frequencies (10 MHz and above) mutual coupling of the button with associated electronics and rest of pad structure becomes an issue. Moreover, electronics itself could create unwanted biases coupled to the buttons and thus driving currents between them.

The principles of the present disclosure are illustrated by FIG. 8. Shown therein is a logging tool with a nonconducting pad 803 and a rugose borehole 801. Two exemplary electrodes 805a, 805b are shown, though in reality, there would usually be many more electrodes. An important difference between the electrode configuration here and in prior art devices is an absence of focusing electrodes and guard electrodes. Instead, each electrode (805a, 805b) is coupled to its corresponding preamplifier (807a, 807b) through a switch (809a, 809b). In the example shown, the switch is depicted as a mechanical device, but any type of switching device could be used, including transistors, integrated circuits, etc. For the purposes of the present disclosure, we use the following definition of a switch: “a device for making, breaking, or changing the connections in an electrical circuit.” The preamplifiers 807a, 807b may be connected to a processor 821.

An important aspect of the present disclosure is that only one of the electrodes (805a, 805b) is connected to a power source at a time. This means that if a measure current is flowing through one of the electrodes, 805a for example, there is no current flowing through any of the adjacent electrodes. The data are acquired sequentially by the individual electrodes rather than the prior art methods of simultaneous acquisition. Consequently, there is no need to use focusing or guard electrodes to prevent leakage current between the electrodes.

There are a number of ways by which the sequentially acquisition can be carried out. This could be done by sequentially connecting and disconnecting the switches 809a, 809b under control of the processor 821, or by disabling input circuits of preamplifiers 807a, 807b under the control of the processor 821.

Besides simplifying the hardware, the method disclosed above also eliminates the galvanic cross-talk between the channels. Based on the discussion above, when there is no current flowing through the other electrodes, the effect of mutual coupling is eliminated.

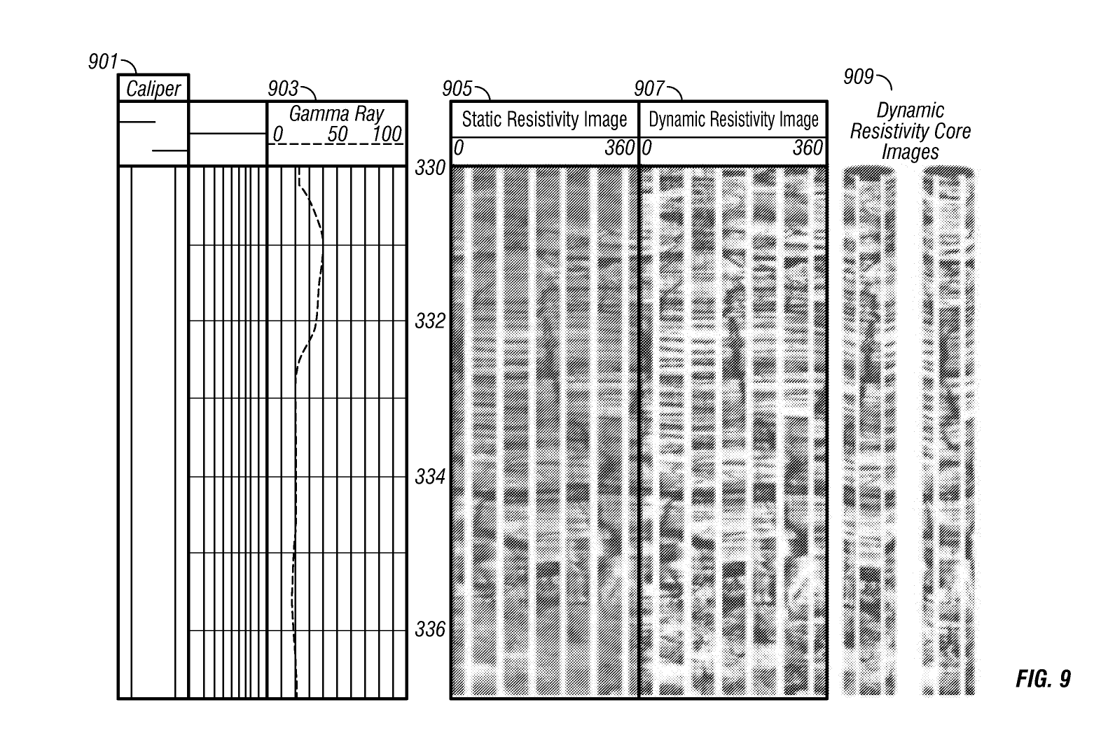

Referring now to FIG. 9, an exemplary image obtained using the Earth Imager® is shown. This is an example of what should be obtainable using the method of the disclosure above. 901 shows the caliper log. 903 shows the gamma ray log. 905 shows a 2-D image of the borehole wall with a fixed gain display. 907 shows a 2-D image of the borehole wall with a dynamic gain applied to the display. 909 shows two isometric views of the borehole wall in cylindrical geometry.

The disclosure above was directed towards a method and apparatus for eliminating the effects of mutual magnetic coupling between currents flowing through different electrodes. In an alternate embodiment of the disclosure, instead of completely eliminating the mutual magnetic coupling, the coupling is mitigated by introducing series impedance at each and every sense electrode. This acts to suppress the differences between the signals at each electrode, thereby reducing the relative magnitude of the cross-coupling. The series impedance can be achieved using a resistor, capacitor or inductor, or by adding an ‘impeding material’ in the current path, such as an insulator in front of the electrodes. While it is obviously not desirable to have a soft material in contact with the borehole wall, such a configuration might be acceptable for imaging a fluid. Mitigation can also be achieved by attempting to calibrate the response in an environment that is substantially similar to the measurement environment, although this is generally much less practical. Reduction of mutual coupling can also be accomplished by increasing the spacing between the electrodes.

A point to note with the present disclosure is that many of the prior art processing methods may also be applied to data acquired using the method of the present invention. This includes, for example, dual frequency focusing (U.S. patent application Ser. No. 11/209,531 of Bespalov et al.).

The invention has further been described by reference to logging tools that are intended to be conveyed on a wireline. However, the method of the present invention may also be used with measurement-while-drilling (MWD) tools, or logging while drilling (LWD) tools, either of which may be conveyed on a drillstring or on coiled tubing. An example of a resistivity imaging tool for MWD use is discloses in U.S. Pat. No. 6,600,321 to Evans, having the same assignee as the present invention and the contents of which are incorporated herein by reference.

Implicit in the processing of the data is the use of a computer program implemented on a suitable machine readable medium that enables the processor to perform the control and processing. The term processor as used in this application is intended to include such devices as field programmable gate arrays (FPGAs). The machine readable medium may include ROMs, EPROMs, EAROMs, Flash Memories and Optical disks. As noted above, the processing may be done downhole or at the surface, by using one or more processors. In addition, results of the processing, such as an image of a resistivity property, can be stored on a suitable medium.

While the foregoing disclosure is directed to the preferred embodiments of the invention, various modifications will be apparent to those skilled in the art. It is intended that all variations within the scope and spirit of the appended claims be embraced by the foregoing disclosure.

1. A method of imaging a resistivity property of a subsurface material, the method comprising:
conveying a logging tool into a borehole, the logging tool having a plurality of measure electrodes;
reducing a mutual coupling between at least one pair of the plurality of measure electrodes;
conveying a first measure current having a first frequency through a first one of the at least one pair of measure electrodes;
conveying a second measure current at the first frequency through a second one of the at least one pair of measure electrodes; and
producing a 2-D image of the resistivity property of the subsurface material using a value of the first measure current and a value of the second measure current.

2. The method of claim 1 wherein reducing the mutual coupling between the at least one pair of measure electrodes further comprises introducing a series impedance with each of the at least one pair of measure electrodes.

3. The method of claim 2 further comprising selecting the series impedance from the group consisting of: (i) a resistance, (ii) a capacitance, and (iii) an inductance.

4. The method of claim 2 wherein reducing the mutual coupling further comprises increasing a spacing between the at least one pair of measure electrodes.

5. The method of claim 1 wherein reducing the mutual coupling between the at least one pair of measure electrodes further comprises:
(i) floating the second one of the at least one pair of measure electrodes while conveying the measure current through the first one of the at least one pair of measure electrodes, and
(ii) floating the first one of the at least one pair of measure electrodes while conveying the measure current through the second one of the at least one pair of measure electrodes.

6. The method of claim 1 further comprising using a return electrode to return the first measure current and the second measure current.

7. The method of claim 5 wherein floating any of the plurality of electrodes further comprises at least one of: (i) disconnecting an electrical connection, and (ii) disabling an input to an amplifier.

8. The method of claim 1 further comprising using a substantially non-conducting fluid in the borehole.

9. The method of claim 1 further comprising conveying the logging tool on one of: (i) a bottomhole assembly on a drilling tubular, and (ii) a downhole logging string conveyed on a wireline.

10. The method of claim 1 further comprising repeating steps (b)-(c) of claim 1 at a second frequency.

11. An apparatus configured to image a resistivity property of a subsurface material the apparatus comprising:
a logging tool having a plurality of measure electrodes configured to be conveyed into a borehole, the logging tool including circuitry configured to reduce a mutual coupling between at least one pair of the plurality of measure electrodes; and
at least one processor configured to:
(A) convey a first measure current having a first frequency through a first, single one of the at least one pair of measure electrodes;
(B) convey a second measure current at the first frequency through a second, single one of the at least one pair of measure electrodes; and
(C) produce an image of the borehole wall of the resistivity property of the subsurface material using a value of the first measure current and a value of the second measure current.

12. The apparatus of claim 11 wherein the circuitry further comprises a series impedance with each of the at least one pair of measure electrodes.

13. The apparatus of claim 11 wherein the series impedance further comprises at least one of: (i) a resistance, (ii) a capacitance, and (iii) an inductance.

14. The apparatus of claim 11 wherein the circuitry further comprises:
(i) a processor configured to float the second one of the at least one pair of measure electrodes while conveying the measure current through the first one of the at least one pair of measure electrodes, and
(ii) a processor configured to float the first one of the at least one pair of measure electrodes while conveying the measure current through the second one of the at least one pair of measure electrodes.

15. The apparatus of claim 11 further comprising a return electrode configured to return the first measure current and the second measure current.

16. The apparatus of claim 14 wherein the processor is further configured to float any of the plurality of electrodes by at least one of: (i) disconnecting an electrical connection, and (ii) disabling an input to an amplifier.

17. The apparatus of claim 11 further comprising a conveyance device configured to convey the logging tool into the borehole, the conveyance device selected from: (i) a drilling tubular configured to convey a bottomhole assembly, and (ii) a wireline configured to convey a logging string.

18. The apparatus of claim 11 wherein the processor is further to repeat steps (b)-(c) of claim 10 at a second frequency.

19. A computer-readable medium for use with an apparatus for imaging a resistivity property of a subsurface material, the apparatus comprising:
(a) a logging tool having a plurality of measure electrodes configured to be conveyed into a borehole, the logging tool including circuitry configured to reduce a mutual coupling between at least one pair of the plurality of measure electrodes, the medium comprising instructions that enable at least one processor to:
(b) convey a first measure current having a first frequency through a first single one of the at least one pair of measure electrodes;
(c) convey a second measure current at the first frequency through a second single one of the plurality of measure electrodes; and
(d) produce an image of the borehole wall of the resistivity property of the subsurface material using a value of the first measure current and a value of the second measure current.

20. The computer-readable medium of claim 19 further comprising at least one of: (i) a ROM, (ii) an EPROM, (iii) an EAROM, (iv) a flash memory, and (v) an optical disk.

21. The method of claim 1, further comprising reducing the mutual coupling between at least one pair of the plurality of measure electrodes without increasing electrode separation.
